(19) United States
(12) Patent Application Publication
(10) Pub. No.: US 2012/0156088 A1
(43) Pub. Date: Jun. 21, 2012

(54) PREPARATION OF FePt AND CoPt NANOPARTICLES

(76) Inventors: Pascal Andre, Raleigh, NC (US); Shu Chen, St Andrews (GB); Kris Anderson, Belfast (GB); Mark James Muldoon, Belfast (GB)

(21) Appl. No.: 13/391,021

(22) PCT Filed: Aug. 17, 2010
(86) PCT No.: PCT/GB10/01555

§ 371 Date: Mar. 6, 2012

(30) Foreign Application Priority Data
Aug. 17, 2009 (GB) 0914390.0

(51) Int. Cl. C22C 5/04; B22F 9/16; B82Y 40/00; B82Y 30/00

(52) U.S. Cl. 420/466; 75/343; 75/363; 977/896; 977/777

(57) ABSTRACT

The invention provides a method for the preparation of FePt or CoPt nanoparticles in ionic liquids, which in certain embodiments constitutes a direct method for the preparation of such nanoparticles having the face-centred tetragonal (fct) crystalline form. The invention also provides FePt or CoPt nanoparticles obtainable by a method of the invention.

### FIELD OF THE INVENTION

The present invention relates to a method for the preparation of FePt or CoPt nanoparticles in ionic liquids, which in certain embodiments constitutes a direct method for the preparation of such nanoparticles having the face-centred tetragonal (fct) crystalline form. The invention also provides FePt or CoPt nanoparticles obtainable by a method of the invention. Face-centred tetragonal FePt and CoPt nanoparticles, and in particular fct FePt nanoparticles, have well-known utility in a variety of applications including use in ultra-high density magnetic recording media as well as numerous biomedical applications.

### BACKGROUND OF THE INVENTION

Iron- and platinum-, or cobalt- and platinum-containing nanoparticles (FePt and CoPt nanoparticles) are of commercial significance because, when in the fct crystalline form (as opposed to the face-centred cubic (fcc) form), these materials have exceptionally high magnetoanisotropy. The magnetic anisotropy of fct FePt nanoparticles can reach 10⁷J/m³, one of the highest values of any known material. Since only nanoparticles having diameters less than 4 nm display superparamagnetic fluctuation at room temperature, this makes fct FePt nanoparticles a promising candidate for future ultra-high density magnetic recording media of greater than 1 Tbit/inch, as well as in magneto-optoelectronic devices (such as sensors, LEDs enhancers and others), in spintronic applications and in numerous biomedical applications including magnetic resonance imaging contrast agents and hyperthermia treatments.

In the discussion that follows, emphasis is directed towards upon FePt nanoparticles. However, those in the art will be aware that the teachings in the art may be applied to CoPt nanoparticles, given the ability of cobalt and platinum to form superparamagnetic nanoparticles of fct crystalline form (see U Jeong et al., Advanced Materials, 2007, 19, 33-60).

In 2000, S Sun et al. (Science, 2000, 287, 198-1992) reported the preparation of FePt nanoparticles based on the reduction of Pt(acac)₂ (acac=acetylacetonate) by a diol, whereby to provide platinum atoms, and the decomposition of iron pentacarbonyl, whereby to provide iron atoms, in high-temperature solutions. Initiation of both reduction and decomposition reaction in the presence of oleic acid and oleyl amine allows preparation of monodisperse FePt nanoparticles.

Whilst the method provided by S Sun et al. represented a great advance over the existing methods in the art at the time, the method does not provide fct FePt nanoparticles directly; these are instead produced by a post-synthetic annealing step conducted at elevated temperatures of the order 500 to 600° C. (typically at temperatures in excess of 550° C.) at which temperatures conversation of the fcc structure to fct is observed. Indeed, only partial chemical ordering (i.e. transformation to the fct phase) is observed by S Sun et al. at temperatures below 500° C. At higher temperature, for example in excess of 600° C., undesirable aggregation and sintering is observed, i.e. an undesirable increase in the average particle size. This is disadvantageous vis-a-vis the magnetic applications for which fct FePt nanoparticles are particularly suitable.

As a consequence of the need to effect a post-synthetic annealing step in accordance with the general method provided by S Sun et al., much effort has been made since the year 2000 to develop a procedure which would allow the direct synthesis of fct FePt nanoparticles, i.e. without the need for the post-synthetic annealing step. For example, M S Wellons et al. (Chem. Mater., 2007, 19, 2483-2488) report a one-step synthesis of fct nanoparticles of approximately 17 nm in diameter by the reductive decomposition of a precursor providing both the iron and platinum components of the desired FePt nanoparticles—FePt(CO)₄dppmBr₂—on a water-soluble support (sodium carbonate). In a method described by K Elkins et al. (J. Phys. D: Appl. Phys., 2005, 38, 2306-2309; and J. Appl. Phys., 2006, 99, Art. No. 08E911), water-soluble salts with melting points higher than 700° C., and having particle sizes smaller than 20 μm, are mixed with fcc FePt nanoparticles in order to ameliorate the disadvantageous sintering that can take place during annealing of fcc FePt nanoparticles. S Kang et al. (J. Appl. Phys., 2005, 97, Art. No. 10J318) report the direct synthesis of FePt nanoparticles that comprise some fct phase by preparing the particles in the high-boiling chemical hexadecylamine, the reflux temperature of which can exceed 360° C. At this temperature fcc FePt particles can be partially transformed into the fct phase. Other high-boiling long-chain hydrocarbon solvents, such as nonadecane, docosane or tetracosane, which allow syntheses to be performed up to 389° C., are reported to lead to violent/uncontrolled reactions when following conventional literature roots to FePt nanoparticles using iron pentacarbonyl (see L E M Howard et al., J. Am. Chem. Soc., 2005, 127, 10140-10141).

There are many other approaches that have been taken to provide alternative and/or improved roots to fct FePt nanoparticles, as well as to fct CoPt nanoparticles, including syntheses using microwave radiation (H L Nguyen et al, (J. Mater. Chem., 2005, 15, 5136-5143); and the direct synthesis of fct FePt nanoparticles at a lower temperature in the presence of poly(N-vinyl-2-pyrrolidone) (T Iwamoto J. Colloid and Interface Science, 2007, 308, 564-567).

Amongst the many other approaches that have been taken, the use of Collman's reagent, (Na₂Fe(CO₄)) has been reported (L E M Howard et al. (infra) and H L Nguyen et al. (Chem. Mater., 2006, 18, 6414-6424) has been described. In these reports, the syntheses of FePt magnetic nanoparticles have been described by heating this iron substrate and Pt(acac)₂ in high-boiling hydrocarbon solvents at high temperature under inert atmospheres so as to allow the direct preparation of fcc FePt nanoparticles directly.

Despite all of these efforts, and others, particularly to allow the direct preparation of fct FePt nanoparticles—i.e. without the need for a post-synthetic annealing step to convert the fcc form to the desired fct form—concerns exist as to the degree of fct crystallinity of directly synthesised fct FePt nanoparticles, given the high temperature of ca. 400° C. typically required for the fcc to fct phase transition (U. Jeong et al., infra).

Ionic liquids have recently been found to be of utility in a number of synthetic applications. These liquids can be advantageous for use as solvents or as other types of continuous liquid phase reaction media on account of their thermal stability, inflammability and lack of volatility. There have been a small number of reports alluding to the use of ionic liquids in the context of nanoparticulate preparation. Specifically, Y Yang and H Yang (J. Am. Chem. Soc., 2005, 127, 5316-5317) describe the synthesis of CoPt nanorods in ionic liquids. In US patent publication no. US 208/0245186 (and corresponding U.S. Pat. No. 7,547,347), entitled “Synthesis of nano-materials in ionic liquids”, a method of synthesising nanoparticles is described that includes combining at least one stabilising agent, at least one precursor and an ionic liquid to form a reaction mixture, heating the reaction mixture to a predetermined temperature to form nanoparticles, causing the nanoparticles to self-separate from the reaction mixture, and collecting the nanoparticles from the reaction mixture. Example 13 in US patent publication no. US 208/0245186 (and corresponding U.S. Pat. No. 7,547,347) describes the synthesis of FePt alloy nanoparticles comprising γ-Fe₂O₃ as a consequence of the reaction between Pt(acac)₂, reduced to metallic platinum by 1-hexandecandiol and iron pentacarbonyl at elevated temperature.

There is no mention in US 2008/0245186 (U.S. Pat. No. 7,547,347) of the preparation of fct FePt nanoparticles. Moreover the conditions described in Example 13 do not appear from the data depicted in FIG. 13A of FIG. 13B to be of fct FePt. There could be a number of reasons for why this is so.

Firstly, the initial reduction of the Pt(acac)₂ by the 1-hexandecandiol may well lead to formation of platinum-based nuclei prior to introduction of the iron pentacarbonyl. This phenomenon is described by M Chen et al. (J. Am. Chem. Soc., 204, 126, 8394-8395). This mechanism of the formation of Pt-rich nuclei coated with iron atoms is also remarked upon by T Osaka (Chem. Lett., 2008, 37(10), 1034-1035). Heterogeneous FePt nanoparticles (e.g. characterised by a Pt or Pt-rich core with deposited Fe atoms thereon) may be expected to present difficulties in achieving transformation to the fct form from the fcc form since this transition is known to be dependent for FeₓPt₁₋ₓ for 0.4<x<0.6 (P Fredricksson (J. Metall., 2004, 33, 183); and P Fredricksson and B Sundman (Calphad, 2001, 25(4), 535), both as reported by H L Nguyen et al., Chem, Mater, 2006, 18, 6414-6424)).

Secondly, the introduction of iron pentacarbonyl (which has a boiling point of 103° C.) at 110° C. may be expected to result in thermal decomposition of iron pentacarbonyl in the resultant gaseous phase. T Osaka et al. (infra) report on inefficient coating of Ft-rich nuclei with iron atoms assumed to be a consequence of thermal decomposition of iron pentacarbonyl evidenced by a cloud of smoke observed in the flask.

Thirdly, the reaction temperature (140° C. being raised to 280° C.) appears, given literature precedent, unlikely under the conditions described to allow preparation of fct FePt. Similar methods involving heating at even higher temperature with Pt(acac)₂ and iron pentacarbonyl as platinum and iron precursors did not result in the preparation of fct FePt, but only fcc FePt (see K E Elkins et al. (Nano Letters, 2003, 3(12), 1647-1649)) where reflux in dioctyl ether at 295° C. provided fcc FePt nanoparticles; and the original S Sun et al. disclosure (infra) (where the same solvent is reported to reflux at 297° C.). Finally, the report of formation of an alloy with γ-Fe₂O₃ suggests oxygen contamination.

T Osaka et al. (infra) describe the preparation of FePt nanoparticles with a narrow size distribution in the ionic liquids 1-ethyl-3-methyl-imidazolium tetrafluoroborate (EMI-BF₄) and 1-butyl-1-methyl-pyrrolidinium trifluoromethanesulfonate (BMP-TF). In this report, Pt(acac)₂ and iron pentacarbonyl were, as is typical, again used as the sources of platinum and iron respectively and a reaction temperature of 230° C. is described. The apparent focus in this paper is on the use of ionic liquids to control the size distribution of the resultant FePt nanoparticles. The nanoparticles prepared are explicitly described as having the fcc structure and no reference to the use of ionic liquids to prepare fct FePt nanoparticles is described.

In conclusion, therefore, despite an enormous amount of research in the art since the synthesis by S Sun et al. (infra) in 2000 of nanoparticulate FePt, there remains a need for alternative syntheses and/or improvements in the preparation of FePt and CoPt nanoparticles, in particular, but not exclusively, the synthesis of fct FePt and CoPt nanoparticles.

### SUMMARY OF THE INVENTION

We have surprisingly found, given the state of the art, that the use of ionic liquids, which permit the access of advantageously elevated temperatures during synthesis, a variety of methods for the preparation of fct FePt and CoPt nanoparticles. Moreover, we have found that precursors to the requisite iron atoms other than Fe(CO)₅ may be utilised in ionic liquid-based syntheses of FePt and CoPt nanoparticles. Advantageously, although not necessarily, synthetic procedures developed as a consequence of this second observation may be used for the direct preparation of fct FePt and fct CoPt nanoparticles. By direct preparation of nanoparticles is meant the preparation of fct nanoparticles without the need for a post-synthetic annealing step, for example one carried out extemporaneously to the synthesis of the nanoparticles of FePt or CoPt.

Viewed from a first aspect, therefore, the invention provides a method of directly synthesising fct FePt or CoPt nanoparticles in an ionic liquid comprising heating in the ionic liquid a mixture comprising a substrate that is capable of providing platinum atoms and a substrate that is capable of providing iron atoms or cobalt atoms whereby to provide said fct FePt or CoPt nanoparticles.

Viewed from a second aspect, the invention provides a method of synthesising FePt or CoPt nanoparticles in an ionic liquid comprising heating in the ionic liquid a mixture comprising a substrate that is capable of providing platinum atoms and a substrate other than iron pentacarbonyl that is capable of providing iron atoms or a substrate that is capable of providing cobalt atoms whereby to provide said FePt or CoPt nanoparticles.

Viewed from a third aspect, the invention provides FePt or CoPt nanoparticles obtainable by a method according to either the first or second aspects of this invention.

Other aspects and embodiments of the present invention will become apparent from the detailed description of the invention that follows below.

### BRIEF DESCRIPTION OF THE DRAWINGS

FIG. 1 shows exemplary structures of some ionic liquids.

FIGS. 2A and B show typical thermogravimetric analysis plots as a function of time and temperature completed under ambient conditions (A) and inert atmosphere (B).

FIGS. 3A to G shows TEMs of FePt nanoparticles made according to the present invention after increasing times and degrees of heating.

FIG. 4A shows XRD patterns of FePt nanoparticles made according to the present invention after heating at 300° C. for 30 minutes, 1 hour and 3 hours. FIG. 4B shows an expanded region of the spectrum in FIG. 4A for 3 hours heating.

FIG. 5 shows SQUID characterisations of FePt nanoparticles made according to the present invention. FIGS. 5A1, 5B1 and 5C1 show ZFC-FC magnetisation curves; FIGS. 5A2, 5B2 and 5C2 show hysteresis curves obtained at 2 K.

FIG. 6 shows a further TEM of FePt nanoparticles made according to the present invention.

FIG. 7A shows an XRD pattern of the same FePt nanoparticles for which a TEM is depicted in FIG. 6, with FIG. 7B showing an expanded region of the XRD spectrum shown in FIG. 7A.

FIG. 8 shows a further TEM of FePt nanoparticles made according to the present invention at four different magnifications.

FIG. 9A shows an XRD pattern of the same FePt nanoparticles for which a TEM is depicted in FIG. 8, with FIG. 9B showing an expanded region of the XRD spectrum shown in FIG. 9A.

FIG. 10 shows a further TEM of FePt nanoparticles made according to the present invention at four different magnifications.

FIG. 11A shows an XRD pattern of the same FePt nanoparticles for which a TEM is depicted in FIG. 10, with FIG. 11B showing an expanded region of the XRD spectrum shown in FIG. 11A.

FIGS. 12A-C show a further TEM of FePt nanoparticles made according to the present invention at three different magnifications. FIG. 12D shows a fast fourier transform (FFD) of the cube depicted in FIG. 12C

FIG. 13A shows an XRD pattern of the same FePt nanoparticles for which TEMs are depicted in FIGS. 12A-C, with FIG. 13B showing an expanded region of the XRD spectrum shown in FIG. 13A.

FIG. 14 shows XRD spectra, with background extracted and normalized (FIG. 14(a)-(c)), TEMs (FIG. 14(d)-(f)), FC-ZFC magnetization curves under 100 Oe (FIG. 14(g)-(i)) and hysteresis loops at 2 K with full hysteresis loops as insert (FIG. 14(j)-(l)) of FePt nanoparticles synthesised for 1 h using Na₂Fe(CO)₄/Pt(acac)₂/[P66614][NTf₂] (FIG. 14(a), (d), (g) and (j)), Fe(CO)₅/Pt(acac)₂/[P66614][NTf₂] (FIG. 14(b), (e), (h) and (k)) and Na₂Fe(CO)₄/Pt(acac)₂/[HMI][NTf₂] (FIG. 14(c), (f), (i) and (l)).

### DETAILED DESCRIPTION OF THE INVENTION

The present invention arises, in part, from the observation that ionic liquids may be used as a reaction medium in which to prepare fct FePt or CoPt nanoparticles and, more generally, to prepare FePt or CoPt nanoparticles from a much wider range of iron atom-providing substrates than has been hitherto recognised within the art.

The invention relates to the preparation of FePt or CoPt nanoparticles. The term “nanoparticles” is an indisputably well-understood term of the art, being almost universally used across the prior art in this area of technology, including almost if not all of the prior art documents referred to in the Background section and other sections herein. Nevertheless, for the avoidance of any doubt, the size implied by the use of the term nanoparticles herein is of particles in which at least one dimension, typically diameter, is in the range of from about 1 nm to about 1000 nm (1 μm). More typically, at least one dimension, typically diameter, is in the range of from about 1 nm 100 nm, consistent with the dimensionality normally ascribed to aspects of nanoscience. Typically, however, the sizes of the nanoparticles of FePt or CoPt described herein are towards the lower end of this range, for example, in the range of from about 1 to about 20 nm. More particularly still, typical sizes of the FePt or CoPt nanoparticles described herein are in the range of from about 2.5 to 5 nm, in particular from about 3 to about 4 nm. As appreciated by those of skill in the art, nanoparticles of fct FePt with dimension (typically diameter) of less than 4 nm display super paramagnetic fluctuation and calculations have indicated that particles of fct FePt as small as 2.8 nm in diameter have a sufficiently high anisotropy energy to be exploited for permanent data storage, with such small sizes in particular offering the opportunity for dramatic increase in storage density in comparison to existing materials. Thus, in specific embodiments of the present invention, FePt nanoparticles described herein are fct FePt nanoparticles have at least one dimension in the range of about 2.8 to about 4 nm. Typically, the FePt particles described herein will be of generally spherical geometry and all the references herein to at least one dimension may be applied to the diameter of such spherical nanoparticles.

In the discussion that follows, emphasis is directed towards those embodiments of the invention concerned with FePt nanoparticles. However, it will be understood from the previous discussion that the invention is not to be understood to be so limited. In particular, it will be understood that, where the context permits, references to sources of iron atoms may be understood to refer to sources of cobalt atoms, whereby to refer to the preparation of CoPt nanoparticles.

The fct FePt nanoparticles provided according to the method of the first aspect of the invention are prepared by heating an ionic liquid comprising a source of both iron and platinum atoms.

The iron atoms may be provided by way of any convenient precursor for iron atoms as known in the art. For example, the iron atoms may be provided as a consequence of decomposition of iron pentacarbonyl, the archetypical source of iron used hitherto in the preparation of FePt nanoparticles. Alternatively, any other convenient source of iron such as an iron (II) or iron (III) salt may be used. Examples include iron (III) ethoxide iron (III) acetylacetonate, iron (II) acetate and iron (II) chloride (see H L Nguyen et al., Chem, Mater, 2006, 18, 6414-6424 and references cited therein and also K E Elkins et al. (Nano Letters, infra) and references cited therein). As a still further alternative, the source of the iron particles can be the same as the source of the platinum particles, for example by way of the provision of a precursor such as FePt(CO)₄dppmBr₂ as reported by M S Wellons et al. (infra).

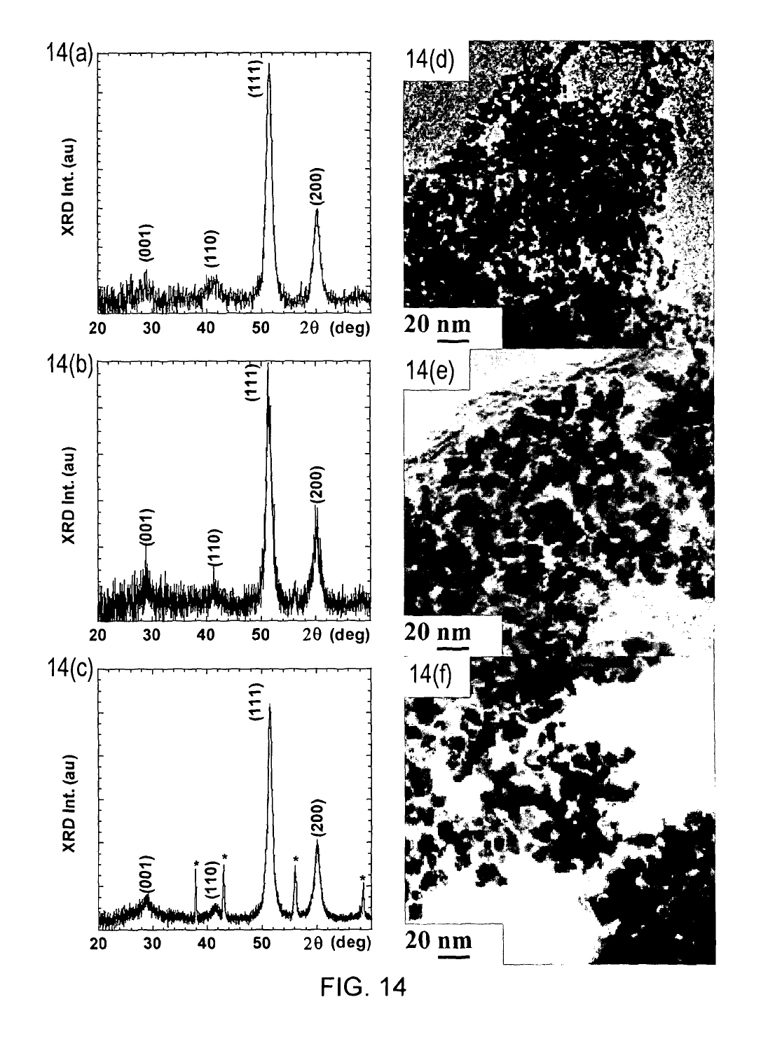

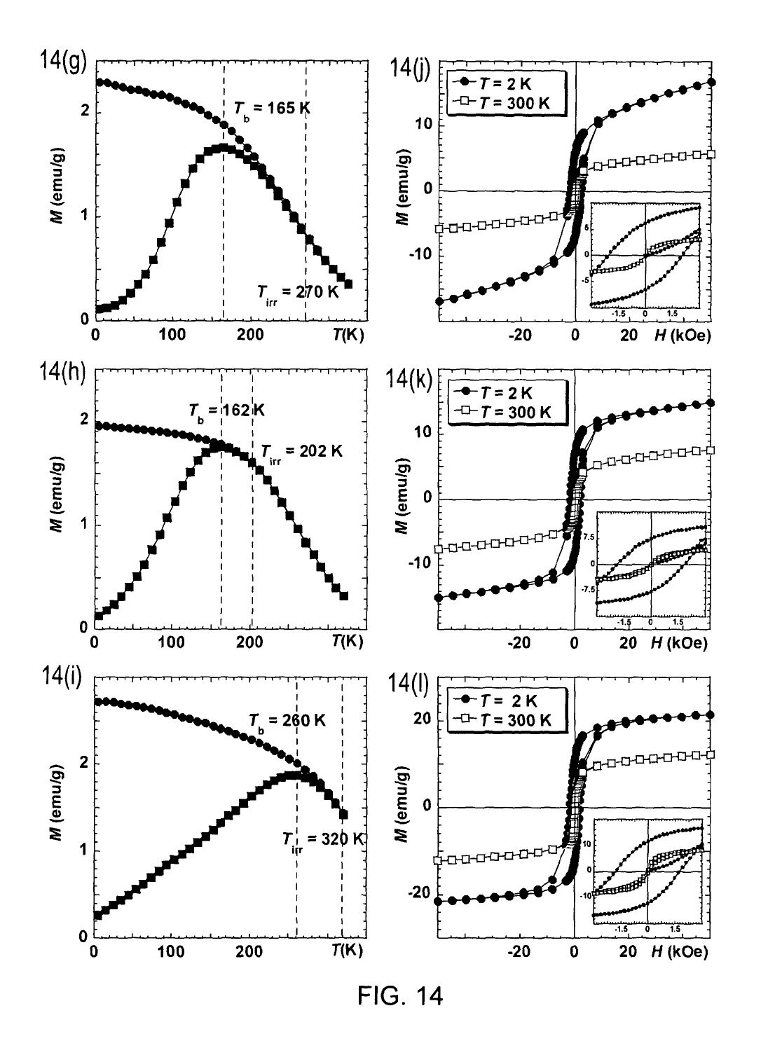

It is particularly important to note that the use of iron pentacarbonyl does not preclude the direct formation of fct FePt nanoparticles by heating in ionic liquid media, which we have demonstrated (see FIG. 14, in particular FIG. 14(b), and the preparative experimental work described below in this connection. With specific reference to the prior art already described above, it has been explained how Example 13 of US patent publication 2008/0245186 (U.S. Pat. No. 7,547,347) is silent regarding and also does not implicitly describe or disclose the preparation of fct FePt nanoparticles. Moreover, it has also been explained how the paper by T Osaka et al. (infra), in which a method of preparing FePt nanoparticles with a narrow size distribution at a temperature of 230° C. did not prepare fct FePt nanoparticles. In brief, Example 13 in the patent publications is likely to have failed to produce fct FePt as a consequence of the generation of Fe-coated Pt or Pt-rich nuclei and the temperature to which the mixture was then heated, particularly given the manner in which the nuclei will have been formed, is insufficient to effect transformations from the fcc to fct crystal phases. In the publication by T Osaka et al., fct FePt is clearly not made (since the authors report the generation of fcc FePt nanoparticles, nor was this intended or likely to have been achieved as a consequence of the temperature to which the reaction mixture was heated, given the surfactants used (oleic acid and oleoyl amine).

In contradistinction to the prior art, introduction of iron pentacarbonyl into the vessel in which it is decomposed to form iron atoms may be at a lower temperature, for example ambient temperature and the reaction then heated so as to avoid the decomposition of the iron pentacarbonyl taking place in the gaseous phase, as distinct from that having the ionic liquid as the continuous phase. If the intrinsic volatility of iron pentacarbonyl remains a problem, a method of the invention may be practised in an autoclave.

Notwithstanding the foregoing, in certain embodiments in of the method according to the first aspect of the invention, the substrate capable of providing iron atoms is other than iron pentacarbonyl.

In embodiments of the invention, the substrate that is capable of providing iron atoms constitutes a compound in which iron is present in an anionic form. In these and most other embodiments of the invention, the substrate that is capable of providing platinum atoms comprises platinum in cationic form, typically in oxidation state II. Particularly advantageous embodiments of the present invention arise form the recognition that the specific combination of precursors comprising cationic platinum and anionic iron allow the preparation of FePt nanoparticles in ionic liquids, which combination confers particular advantages over the prior art. These advantages include the ability to tailor the stoichiometry of the iron to platinum ratio within the FePt nanoparticles, the ability to generate FePt nanoparticles having a more predictable homogeneity in terms of an approximately 1:1 stoichiometric distribution of iron and platinum atoms within the nanoparticles; and the ability to provide fct FePt nanoparticles directly from the reaction between the anionic iron and cationic platinum-containing precursors in the ionic liquids. In these particular embodiments of the invention, therefore, the reduction of the cationic platinum-containing species to elemental (metallic) and oxidation of the anionic iron-containing species to elemental (metallic) iron occur within the ionic liquid.

The use of a precursor for the elemental iron in anionic form is characteristic feature of many embodiments the present invention. Introduction of the iron in this form offers significant advantages over iron pentacarbonyl, which has been the prevalent iron source used to date in the preparation of FePt nanoparticles. Typically, as noted above the anionic-containing precursor from which the FePt nanoparticles are synthesised will be present in a compound comprising Fe²⁻ anions. A particular embodiment of this is Collman's reagent, Na₂Fe(CO)₄, which is commercially available, for example as a dioxane complex. The invention is by no means so limited and the skilled person will be aware of other sources of anionic iron, in particular having an oxidation state of −II. Such complexes are readily available and known to the skilled person and include complexes formed between Fe²⁻ and ligands such as carbon monoxide, nitrous oxide and phosphines. A specific example of an additional compound that may be used according to these embodiments of the present invention is Fe(CO)₂(NO)₂. Other examples of anionic iron-containing substrates that may be used in accordance with the present invention will be evident to those of skill in the art. Analogously, with those embodiments of the invention directed towards CoPt nanoparticles, the use of anionic cobalt-containing precursors (particularly those of oxidation state (−I) will be well within the ability of those skilled in the art, two examples being NaCo(CO)₄ and Co(CO)₃(NO).

As for the source of atomic platinum, there is no particular limitation as to the platinum-containing salt that may be employed. Typically the source of platinum will be a platinum (II) salt such as Pt(acac)₂, which is customarily used in the art.

Advantageously, the relative reaction kinetics of the Fe/Co and Pt precursors should be kept in mind when selecting sources for the metals in the desired nanoparticles. In this regard sources of atomic platinum tend to react more quickly implying that Fe/Co precursors may advantageously be chosen to be less stable than the source of atomic platinum, e.g. (Pt(acac)₂). Typically, and whilst keeping everything else constant, X(acac)_{y} (X, y=Co, 2; Fe, 3)+Pt(acac)₂ seem to lead to a very large amount of Pt metal. Therefore, another set of ligands may be used to either slow down Pt(acac)₂ precursor kinetics or increase Fe/Co kinetics. Such selections/modifications are within the routine ability of those of normal skill.

A specific advantage of using anionic source of iron and a cationic source of platinum is that the anionic iron-containing compound serves as a reducing agent for the cationic platinum species in the preparation of the FePt nanoparticles. This has the twin advantages that greater control over the stoichiometry can be achieved since generation of the desired atoms of iron and platinum are it will be appreciated, somewhat mutually dependent. Indeed, where Fe²⁻- and Pt²⁺-containing species are employed, a 1:1 theoretical stoichiometry is achieved. Control over the stoichiometric outcome during formation of the FePt nanoparticles is beneficial since it has been reported in the literature that fct formation is observed only in. Thus in particular embodiments of the invention the FePt nanoparticles are of this stoichiometry, i.e. have a value of x between about 0.4 and about 0.6 (with respect to FeₓPt₁₋ₓ). The skilled person is also aware, however, that FePt coercivity is understood to be maximised at a slight iron-rich ally composition, for example in which the x with respect to FeₓPt₁₋ₓ is in the range of in excess of about 0.52 to about 0.60 (see S Sun et al. (infra).

Where a mutually interdependent system of providing the desired atomic iron and platinum is used, it will be appreciated that it is not necessary (although is not excluded) for there to be a specifically added reducing agent to reduce the cationic platinum-containing substrate (e.g. Pt(acac)₂) to atomic platinum since the anionic iron will serve to reduce the cationic platinum. Thus, in certain, but not all, of these embodiments of the invention, a specific non-iron-containing reducing agent, such as the 1,2-hexadecanediol or polyalcohol (for example ethylene glycol, oligoethylene glycol (e.g. tetraethylene glycol) or glycerol) used in the prior art to reduce the cationic platinum to atomic platinum is absent. In this way, it may regarded that these embodiments of the invention comprise the heating of a mixture consisting essentially of a cationic platinum-containing substrate, an anionic iron- (or cobalt-) containing substrate, an ionic liquid and, optionally, one or more surfactants that serve to stabilise, and so allow formation of, the FePt nanoparticles, and, as a further optional alternative, a silver-containing substrate (further details of which are provided below). This is because the presence of an additional reductant (in addition to the anionic iron-containing substrate) will materially affect the nature of the composition.

In other embodiments of the invention, however, the possibility of an additional reductant is not excluded and may be selected from any reductant customarily used in the art, such as a diol or a polyalcohol (e.g. ethylene glycol, glycerol or 1,2-hexadecanediol to name but three examples). Other examples of suitable reductants, typically diols or polyalcohols, will be evident to those skill in the art. For example, where both substrates for the desired iron and platinum atoms are cationic, for example where Fe(III)(acac)₃ and Pt(II)(acac)₂ are employed (see K E Elkins et al. (Nano Letters, infra) a reductant will be present.

In the method according to the second embodiment of the invention, the substrate capable of providing iron atoms is not iron pentacarbonyl. However, apart from this difference, the iron- and platinum containing substrate(s) may be as is described above in accordance with the method according to the first aspect of the invention.

A characteristic feature of the present invention is the formation of the desired nanoparticles in ionic liquids. The nature of Ionic liquids is well known to those of skill in the art. Broadly speaking, an ionic liquid is salt, but one in which the ions are insufficiently well-coordinated for the compound to be other than a liquid below 150° C., more usually below 100° C., and in some embodiments even at room temperature—so-called room-temperature ionic liquids. In other words, ionic liquids are salts that form stable liquids at temperatures below 150° C. or lower. There are no particular limitations as to the specific types of ionic liquids that may be used in accordance with the present invention. One or more ionic liquids may be used. As will be appreciated, one of the specific advantages that use of ionic liquids confers is removal of the need to have a condenser in order to achieve a high-temperature liquid environment in which the method of the present invention may be conducted. Ionic liquids, with inherently low vapour pressure, allow the maintenance of constant temperature to be achieved over the course of the method of the invention, in contrast to the significant vapour pressures of the high-boiling point solvents typically used in the prior art. Such solvents inevitably cause a decrease in the temperature of a reaction vessel when the solvent condenses back in. Ionic liquids, therefore, permit not only an advantageously elevated temperature (vis-a-vis many solvents in which FePt (and CoPt) nanoparticles have been produced in the prior art) but allow a more homogeneous temperature to be maintained throughout the reaction. An example of this may be understood with reference to benzyl ether, which induces a temperature drop of about 20° C., whereas all the syntheses carried out to date in accordance with the present invention have not shown any temperature drop. Typically, the ionic liquids of the present invention have either no, or negligible, vapour pressure.

Organic cations that may be present in ionic liquids may include, for example, quaternary ammonium, phosphonium, heteroaromatic, imidazolium and pyrrolidinium cations. The counteranions present in ionic liquids are likewise not particularly limited. For example, suitable anions include halide (e.g. chloride or bromide), nitrate, sulfate, hexafluorophosphate, tetrafluoroborate, bis(triflylmethylsulfonyl)imide, (the bis(triflylmethyl sulfonyl)imide anion being abbreviated here as [NTf₂]; it is also sometimes referred to as [Tf]N2 or [Tf]2N) anions. Others will be evident to those of skill in the art.

According to particular embodiments of this invention the or an anion of the ionic liquid is [NTf₂]. Without wishing to be bound by theory we believe that the structure of this anion, with its four oxygen atoms, may be advantageous in relation to the formation of fct nanoparticles, possibly by allowing simultaneous bonding to at least two precursors. Other anions having similar functionality, and consequential ionic liquids, will be evident to those of skill in the art.

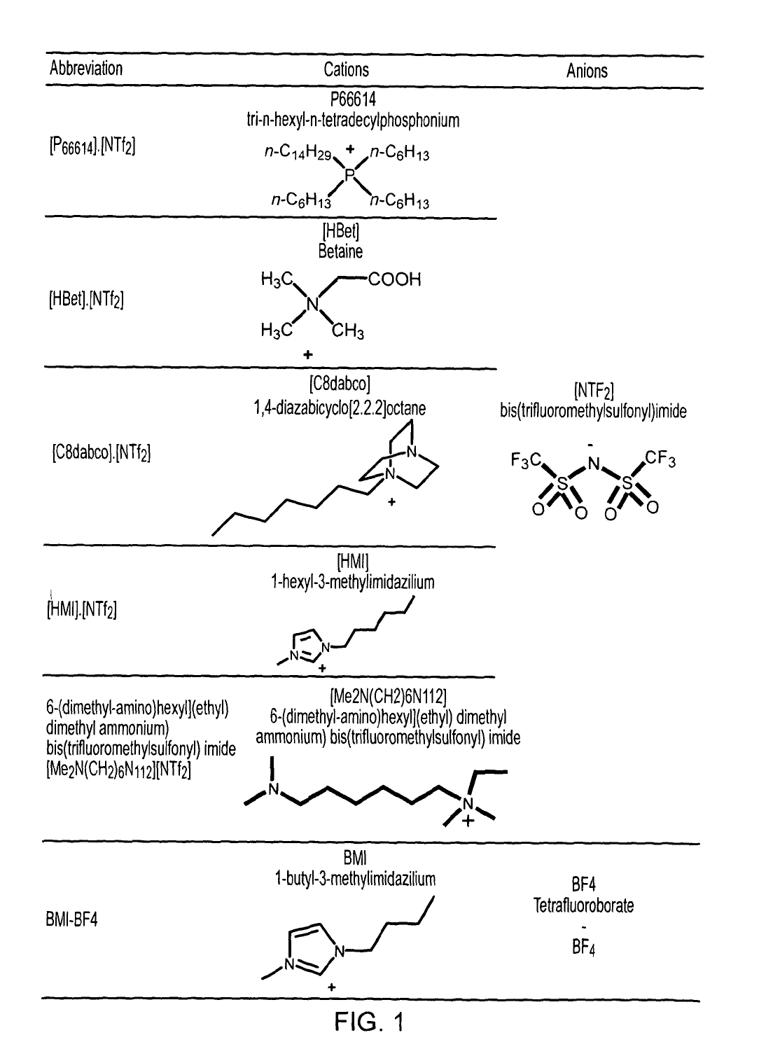

Ionic liquids that may be used in include 1-butyl-3-methylimidazolium bis(trifluoromethylsulfonyl)imide, 1-n-butyl-3-methylimidazolium hexafluorophosphate, 1,1,3,3-tetramethylguanidinium lactate, N-butylpyridinium tetrafluoroborate, 1-butyl-3-methylimidazolium tetrafluoroborate, 1-ethyl-3-methylimidazolium bis(trifluoromethyl sulfonyl)imide 1-ethyl-3-methyl-imidazolium tetrafluoroborate, 1-butyl-1-methyl-pyrrolidinium trifluoromethanesulfonate and thiol-functionalised ionic liquids. Examples of ionic liquids that may be used in accordance with the present invention, including P66614[NTf₂], [Hbet].[NTf₂], [C8dabco].[NTf₂], Me₂N(CH₂)₆N₁₁₂][NTf₂] and BMI-BF4, are depicted in FIG. 1 and these are all available commercially, e.g. from Cytec Industries, Inc., (including by contractual arrangement with the Ionic Liquids Laboratory at the Queens University of Belfast (see quill.qub.ac.uk for further details)).

Ionic liquids can be engineered to tune their advantageous properties such as stability, vapour low pressure and solvating ability so as to be safer and more environmentally friendly than conventional volatile, organic compounds. Consequentially, and because of the possibility of recycling, use of ionic liquids can simplify synthetic reactions when it is possible to substitute such ionic liquids for conventional solvents.

As will be understood with reference to the experimental section below, certain ionic liquids (including tri-n-hexyl-n-tetradecylphosphonium bis(trifluoromethylsulfonyl)imide, (referred to herein as P66614[NTf₂]; and commercially available from Cytec Industries, Inc.) as a representative example of an ionic liquid, is susceptible to decomposition at temperature above 240° C. in a normal oxygen-containing atmosphere. However, as is described in more detail below, only limited decomposition of ionic liquids is observed at elevated temperatures where heating is conducted in an inert atmosphere. Accordingly, in many embodiments of the invention, the conduct of a method is practised under an inert atmosphere. Methods of achieving appropriate inert atmospheres (i.e. those from which oxygen is substantially excluded) are well known to those of skill in the art and may be provided through the use of argon, nitrogen or other gases. In certain embodiments, heating of mixtures to temperatures of approximately 100 to 150° C. in order to remove any residual oxygen or moisture from the component that are subsequently heated to higher temperature.

In addition to the materials that serve to provide the required atomic iron and platinum, and the ionic liquid, in certain embodiments of the additional presence of surfactants that are not ionic liquids may be advantageous. Without wishing to be bound by theory, and summarising the various commentary in the art, these may serve to stabilise atomic iron, atomic platinum, or (nascent) FePt nanoparticles. Suitable surfactants, which will be understood as effectively functioning as stabilising agents enabling the FePt nanoparticles to be formed within the ionic liquid, may be carboxylic acid or amines, particularly primary amines in which the carboxylic acid or amino (e.g. primary amino) functionality is attached to an alkyl or alkenyl chain typically comprising from 6 to 30 carbon atoms. At least one amine and at least one carboxylic acid are typically included, typically one of each. In certain embodiments of the invention the ratio of acid: amine (if both are used) is between about 1:5 and about 5:1, e.g. between about 1:1 and about 3:1, for example about 2:1. Examples of carboxylic acid-containing surfactants include oleic acid and stearic acid. Examples of amines that may be used include oleyl amine and hexadecyl amine. Surfactants are understood to serve as dispersants that assist in the preparation of the desired nanoparticulate FePt or CoPt. In certain embodiments of the invention both oleic acid and oleyl amine are included, often in the ratios described herein.

The ratio of the surfactants to the iron- (or cobalt-) and platinum-containing precursors may be varied and this may be advantageous to undertake in certain embodiments of the invention, since adjusting these ratios can affect the size and or ability to change phase of the resultant nanoparticles (see for example the paper by M Chen et al., infra.

Likewise, the temperature at which the reaction is conducted may be varied with the routine ability of those skilled in the art so as to affect the outcome of the methods of the present invention. It will be understood, both from the detailed discussion hereinbefore, and by the skilled person, that generally higher temperatures will be expected to favour transformation of fcc crystalline forms to the fct polymorph. It will also be understood that prolonged exposures to elevated temperatures, for example, for more than about 3 hours at more than about 300° C. can induce generally undesired sintering of fct (or fcc) crystalline forms. Likewise, fcc to fct transition tends not to take place below about 250 to 300° C. Typically, if the fct crystalline form is desired, then heating may be advantageously conducted at a temperature of between about 250 and about 380° C. (for example between about 295 to about 300° C., or between about 300 to about 350° C.) for between about 15 minutes to about 4 hours, for example between about 30 minutes and one or two hours. It will be appreciated, however, that the most appropriate reaction conditions, such as heating time and duration, may be determined at will be the skilled person using analytical methodologies such as X-Ray diffraction (XRD) and transmission electron microscopy (TEM) the use of which is described in the experimental section below. The skilled person is aware that, by calibrating peaks in X-Ray diffractograms, polymorphic ratios (e.g. fcc:fct) may be calculated.

Whilst heating (time and duration) at the ultimate temperature to which the ionic solution is raised is an important consideration, it is also useful in certain embodiments to heat the initially added materials to a temperature intermediate between that at which the components submitted to the method are initially introduced, e.g. room temperature (e.g. about 20° C., and that to which they are ultimately heated, e.g. about 320 to about 350° C. Thus, for example, it may be convenient to heat the reaction mixture that is subsequently heated to higher temperature (and optionally pressure, if heating in an autoclave is undertaken), to a temperature of between about 80 to about 200° C., for example between about 120 to about 180° C., for a period of between about 15 minutes and about 3 hours (or more), typically for about an hour. Imposition of such an intermediate heating regimen can have a number of advantageous effects, such as conferring a greater homogeneity of distribution of the materials dispersed or dissolved within the ionic liquid, which can manifest itself in a higher quality or more desirable outcome during later phase transition (if such is desired); by ridding the solvent of undesirable oxygen or moisture; and increasing the opportunities for complexes with the ligands (e. g. surfactants) to form.

These considerations notwithstanding, it is known from the art that the Tₜ can be varied with judicious use of surfactants (see for example the discussion by T Iwamoto et al., infra. Indeed, in certain embodiments of the invention the stabiliser included within the mixture that is heated to provide the FePt nanoparticles is poly(N-vinyl-2-pyrrolidone) (PVP) as described more fully by T Iwamoto et al. (infra). As described more fully in that publication, PVP is believed to be advantageous in allowing a reduction in the temperature in the temperature at which fcc FePt nanoparticles transform to the fct form.

In other embodiments of the invention no specific stabiliser is added. The possibility to omit a specific stabiliser, which according to many embodiments of the invention and hitherto has been typically a combination of oleic acid and oleoyl amine, may be understood to be achievable for two reasons. Firstly, because of the inherent charge associated with ionic liquids, these may serve to function as dispersants as well as solvents (or other continuous liquid phases) during the preparation of FePt nanoparticles as alluded to by T Osaka (infra).

Other factors, such as the rate at which the mixture is heated, either to an intermediate temperature (if any) as described herein, or at the temperature to which the mixture is ultimately heated, may affect the size of the nanoparticles. Typical heating rates may be between about 1 to about 20° C./min, e.g. between about 5 to about 15° C./min. Another factor is the additional injection of precursors after a reaction mixture is heated, e.g. in accordance with a method of the present invention, e.g. whereby to provide fct FePt nanoparticles. Injection of material in this way can be advantageous in allowing subsequent FePt material to adopt the crystallinity of the existing nanoparticles (e.g. fct) yet provide larger nanoparticles, which may be useful for certain applications.

In certain embodiments of the invention, one or more metals additional to iron or cobalt and platinum, such as copper, zirconium, aluminium, silver and gold, may be incorporated into the desired nanoparticles. Silver atoms, in particular, are known to enhance magnetisation and propensity to transform to fct significantly (see for example L Castaldi et al., J. Appl. Phys, 2009, 105, Art No. 93914). In some of these embodiments, it may regarded that such methods of the invention comprise the heating of a mixture consisting essentially of a platinum-containing substrate, an iron- or cobalt-containing substrate, a silver-containing substrate, an ionic liquid and, optionally, one or more surfactants that serve to stabilise, and so allow formation of, the FePt or CoPt nanoparticles.

It will likewise be appreciated that ionic liquids can be recycled, providing a still further advantage of the present invention over traditional solvents used in the art hitherto. For example, extraction of the nanoparticles produced, e.g. by magnetic extraction from the ionic liquid, as opposed, for example, to a work up involving addition of an alcoholic solvent such as ethanol and washing with hexane solvent (to give on example) may permit with ease the recycling of the ionic liquid solvent and development of continuous flow systems.

All literature and patent publications referred to herein are hereby incorporated by reference in their entirety as if, at each reference to such a publication, the entirety of the publication were reproduced at such a juncture in its entirety.

The intention is now illustrated by the following non-linking examples:

### Materials

Platinum(II) acetylacetonate, Pt(acac)₂, 99.99%, disodium tetracarbonylferrate-dioxane complex (1:1.5), Na₂Fe(CO)₄.1.5C₄H₈O₂, oleylamine (70%), oleic acid (90%) were purchsed from Sigma-Aldrich. Dibenzyl ether, (C₆H₅CH₂)₂O, ≧98.0% was obtained from Fluka.

Ionic liquids were provided by School of Chemistry and Chemical Engineering, Queen's Belfast University.

All chemicals were used without further purification while liquids were degassed before use.

### Syntheses

### General Procedure

All syntheses were carried out inside a glove box. A mixture of Pt(acac)₂ (0.2 mmol), oleyl amine (1.6 mmol) and oleic acid (0.8 mmol) in 2 ml of ionic liquid (P66614.[NTf₂]), placed in 25 mL round bottom flask connected with a condenser. The mixture was kept under stirring and heated up to 100° C. for 1 h to get remove residual O₂ and moisture.

The same treatment was applied to Na₂Fe(CO)₄ (0.2 mmol) dissolved in 2 mL of the same ionic liquid.

The 2 solutions were then mixed afterwards & heated up to 150° C. for 1 h.

The reaction mixture was further heated up to 300° C. for 1 to 3 h to investigate the grow mechanism.

After reaction, the solution was cooled down to ambient temperature. Nanoparticles were precipitated by ethanol addition & centrifugation. After discarding the supernatant, the precipitates were dispersed with hexane, precipitated by ethanol & collected by centrifugation. This procedure was repeated several times.

Time investigation: nanoparticles were obtained samples at different time points by extracting aliquots of 0.5 mL of reaction solution mixed with 4 mL ethanol at RT to quench the synthesis (H. G. Bagaria et al., J Appl Phys 2007, 101 (10)).

### Characterisation Techniques: Nanoparticles

TEM, SQUID , XRD and EDAX

The strongest (111) peak was fitted with Lorentzian-shaped peaks by nonlinear least-squares procedures included in STOEwinXpow & KaleidaGraph software to determine 26. Crystalline grain size D of FePt NPs is calculated according to Scherrer's formula.

The composition FeₓPt₁₋ₓ value was calculated according to Vegar's law (J. W. A. Bonakdarpour, et al., J. Electrochem. Soc. 2005, 152, A61-72).

### Thermogravimetric Analysis (TGA)

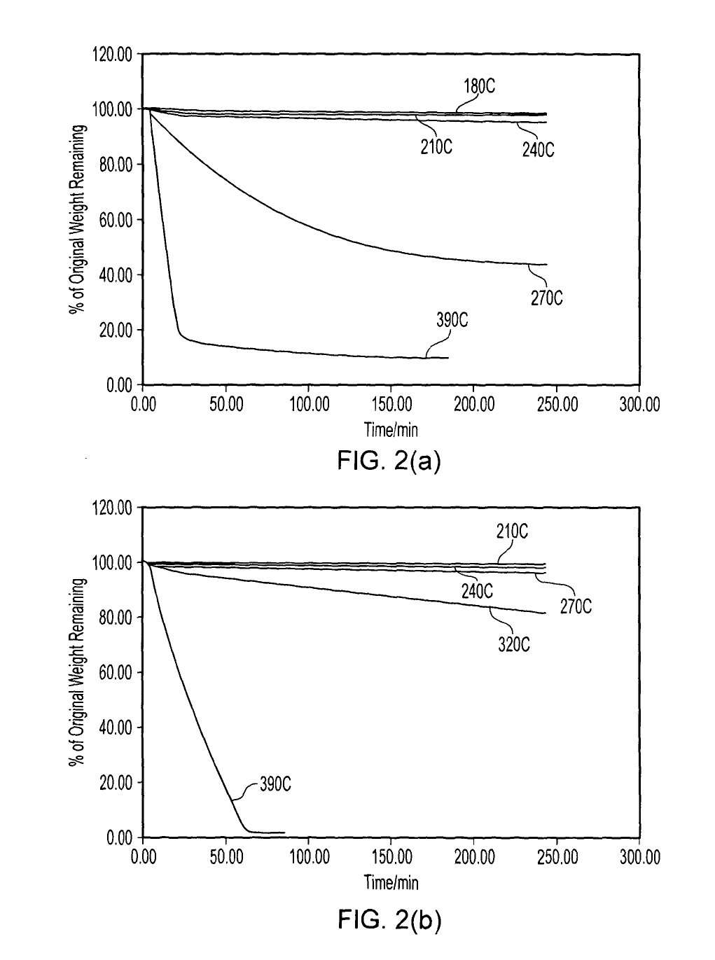

TGA provides mass losses as a function of time. Under ambient (i.e. non-inert) conditions, ionic liquids begin to decompose rapidly at temperatures above 240° C. after one hour at 270° C. a sample tested lost over a quarter of its weight demonstrating that the oxygen present in air can assist in the decomposition of the ionic liquid. TGA was also carried out in an inert atmosphere. Typical plots are depicted in FIG. 2. After one hour at 320° C., the ionic liquid had lost only 5% of its mass and there were no significant weight losses were experienced at 270° C. Under inert atmospheric conditions, therefore, ionic liquids display an improved stability over traditional solvents allowing nanoparticles syntheses at higher temperatures and with limited decomposition of the liquids.

### Characterisation of FePt Nanoparticles by Transmission Electron Microscopy (TEM).

FIG. 3 shows TEM spectra of FePt nanoparticles synthesised in P66614.[NTf₂] as solvent. The concentration of both iron and platinum precursors were 0.05 M respectively. [Na₂Fe(CO)₄]=[Pt(acac)₂]=0.05 M, [oleyl amine]/[Pt(acac)₂]=8, [oleic acid]/[Na₂Fe(CO)₄]=4. The heating rate was 15° C./min. Samples were withdrawn at [A] 200° C., (B) 250° C., (C) 300° C. (beginning), (D) 300° C. after 30 mins, (E) 300° C. after one hour, (F) 300° C. after two hours and (G) 300° C. after three hours.

FIGS. 3A shows mainly nuclei (depicted light in colour) and small spherical nanoparticles (dark in colour). At 250° C. (FIG. 3B) there are clearly identifiable well-dispersed nanoparticles. At 300° C. (FIGS. 3C-G), the nanoparticles gradually fused, with the number of fused nanoparticles cluster increasing over the time the reaction mixture is held at 300° C. From the time heating reaches 300° C. until 30 minutes after heating at 300° C., (FIGS. 3C and 3D), well-dispersed nanoparticles are still clearly visible. FIG. 3E shows that, after one hour at 300° C., a small proportion of nanoparticles have fused and, after 2 and 3 hours FIGS. 3F and 3G) a significant number of nanoparticles have sintered.

### Reaction Time Investigation by X-Ray Defraction (XRD)

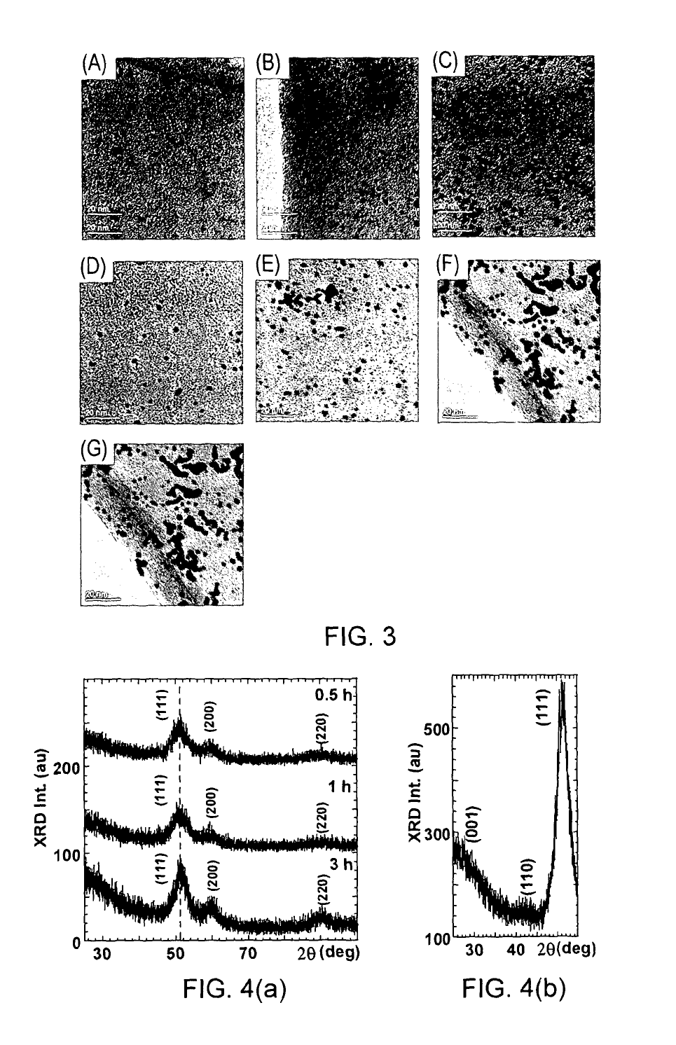

Simultaneous monitoring of the crystallinity was achieved by XRD, as shown in FIG. 4 and Table 1. FIG. 4A shows the XRD pattern of FePt nanoparticles synthesised in solvent P66614.[NTf₂] (twice to 0 step size: 0.02, time/step: 260 s), [Na₂Fe(CO)₄]=[Pt(acac)₂]=0.05 M, [oleyl amine]/[Pt(acac)₂=8, [oleic acid]/[Na₂Fe(CO)₄]=4. The heating rate was 15° C./min. Samples were withdrawn at 300° C. after 30 mins, one hour and three hours as depicted in FIG. 4A. FIG. 4B shows the XRD pattern of a sample withdrawn after 3 hours (26 step size: 0.02, time/step: 1800 s).

After 30 minutes and one hour XRD revealed the crystalline size to be approximately 2 nm, consistent with the TEA results, with, XRD peaks corresponding to (111) and (200). After 3 hours at 300° C. the crystalline size increased to approximately 3 nm with XRD peaks sharper because of larger fused nanoparticles with (220) now discernable. The lattice spacing was slightly decreased and the (111) position shifted towards higher values as would be expected for fct structured particles. FIG. 4B in particular shows XRD measurements over a long time scale clearly showing (001), (110) peaks characteristics of fct crystalline phase.

TABLE 1
XRD data of FePt NPs synthesized in P66614.[NTf₂] solvent.

| | | | | x in |
|---|---|---|---|---|
| Reaction | 2θ of (111) | a | D_{XRD} | FeₓPt₁₋ₓ |
| time H | (degree) | (Å) | (nm) | (%) |
| 0.5 | 51.286 ± 0.039 | 3.8743 ± 0.0030 | 2.4 ± 0.1 | 40.2 ± 2.2 |
| 1.0 | 51.217 ± 0.038 | 3.8792 ± 0.0029 | 2.2 ± 0.1 | 39.0 ± 2.1 |
| 3.0 | 51.412 ± 0.032 | 3.8655 ± 0.0020 | 3.2 ± 0.1 | 42.3 ± 1.4 |

Samples were withdrawn at 300° C. 30 min, 1 h and 3 h.
2θ is the position of the (111) peak,
a is the lattice constant,
D_{XRD} is the crystalline grain size,
x is the iron content is FeₓPt₁₋ₓ.
(throughout the whole synthesis % Fe is constant within experimental uncertainty and around 40%).

Reaction Time Investigation: SQUID

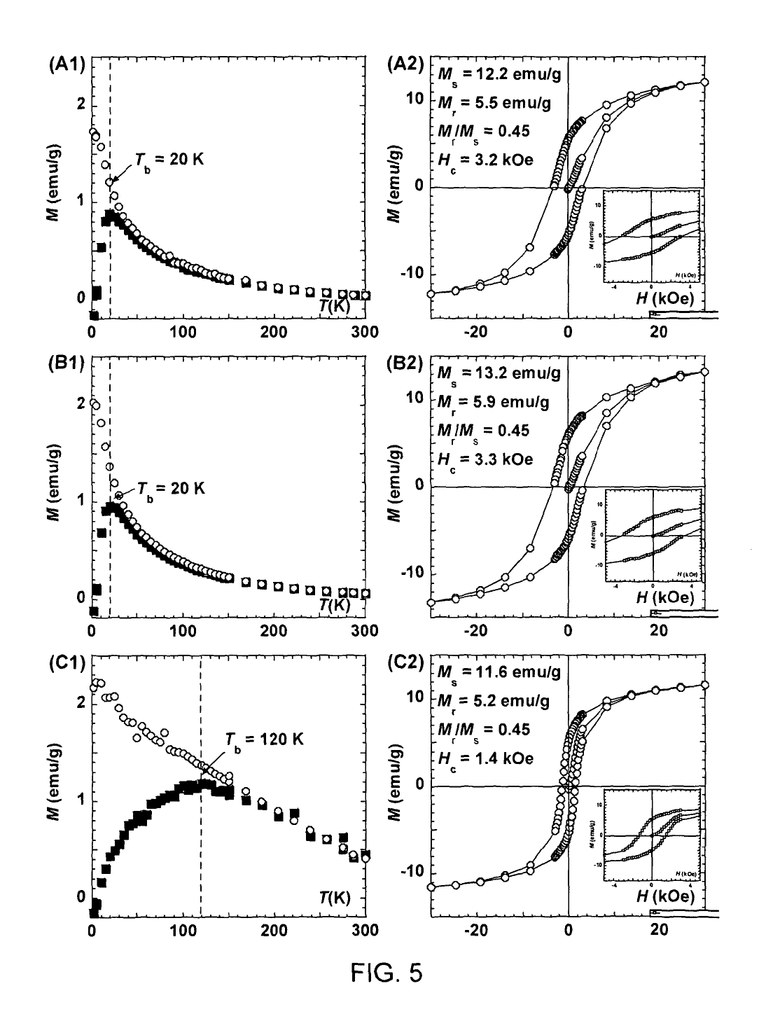

Nanoparticles were dispersed in PMMA matrix to reduce interaction that would otherwise have reduced magnetism and coercivity. The evolution of the magnetic properties are depicted in FIG. 5 with the left hand column (FIGS. 5A1, 5B1 and 5C1) showing FC-ZFC curves whilst the right-hand column (FIGS. 5A2, 5B2 and 5C2) depicts hysteresis curves obtained at 2 K. These data are also summarised in Table 2.

TABLE 2
Magnetic properties of the FePt NPs synthesized in P66614.[NTf₂]
solvent.

| | | H_{c} | Mₛ | Mᵣ | Mₛ/Mᵣ |
|---|---|---|---|---|---|
| Reaction time H | T_{b} K | Koe | emu/g | emu/g | — |
| 0.5 | 20 | 3.2 | 12.3 | 5.5 | 2.2 |
| 1.0 | 20 | 3.3 | 10.2 | 4.5 | 2.3 |
| 3.0 | 120 | 1.4 | 7.7 | 3.5 | 2.2 |

T_{b} is the blocking temperature,
H_{c} is the coercivity,
Mₛ the magnetisation at saturation,
Mᵣ the remanent magnetisation and Mₛ/Mᵣ their ratio

### ZFC-FC Curves

The initial particles show a magnetic behaviour relatively independent of the reaction time, with a blocking temperature (T_{b}) of around 20 K. In contrast, the T_{b} is much higher with the sample after 3 hours at about 120 K.

### Hysteresis Loops

FIGS. 5A2 and B2 shows increasing of Ms from 12.2 to 13.2 emu/g & Mr from 5.5 to 5.9 emu/g as the reaction time is increased from 0.5 h to 1 h, which may indicate larger particle or better crystallinity with longer heating times. In contrast, the decrease of Ms from 13.2 to 11.6 emu/g, Mr from 5.9 to 5.2 emu/g & Hc from 3.3 to 1.4 kOe as the reaction time is increased from 1 h to 3 h, may be caused by the polycrystalline structure of those fused NPs, as intergranular exchange couple leads to reduction of magnetocrystalline anisotropy (see Rong et al., Adv. Mater., 2006, 18(22), 2984-2988). The reduced coercivity may also be attributed to the magnetic dipole coupling between nanocrystals. NPs samples were dispersed in PMMA matrix to reduce to the magnetic dipole coupling as much as possible. However, the aggregation of nanoparticles after 3 h may increase possibility the magnetic dipole coupling. Very likely that magnetic dipole coupling between aggregated nanocrystals is reducing the coercivity and also leads to the constricted hysteresis loops, see insert hysteresis loop in FIG. 5C2 vs. in FIG. 5A2 & 5B2 (see Lee et al., Phys Chem B, 2006, 110(23), 11160-11166).

### Increasing Size of Nanoparticles: Heating Rate

The general procedure described above was modified (to [Na₂Fe(CO)₄]=[Pt(acac)₂]=0.05 M, [oleylamine]/[Pt(acac)₂]=8, [oleic acid]/[Na₂Fe(CO)₄]=4. Heat rate 5° C./min) by reduced heating rate from 15 to 5° C./min to reduce nucleation rate (E. V. Shevchenko et al., J. Am. Chem. Soc., 2003, 125(30), 9090-9101; S. Saita and S. Maenosono, Chem. Mater., 2005, 17(26), 6624-6634; and V. Nandwana et al., J. Phys. Chem. C, 2007, 111(11), 4185-4189).

Synthesis kept at 300° C. for 1 h to reduce aggregation

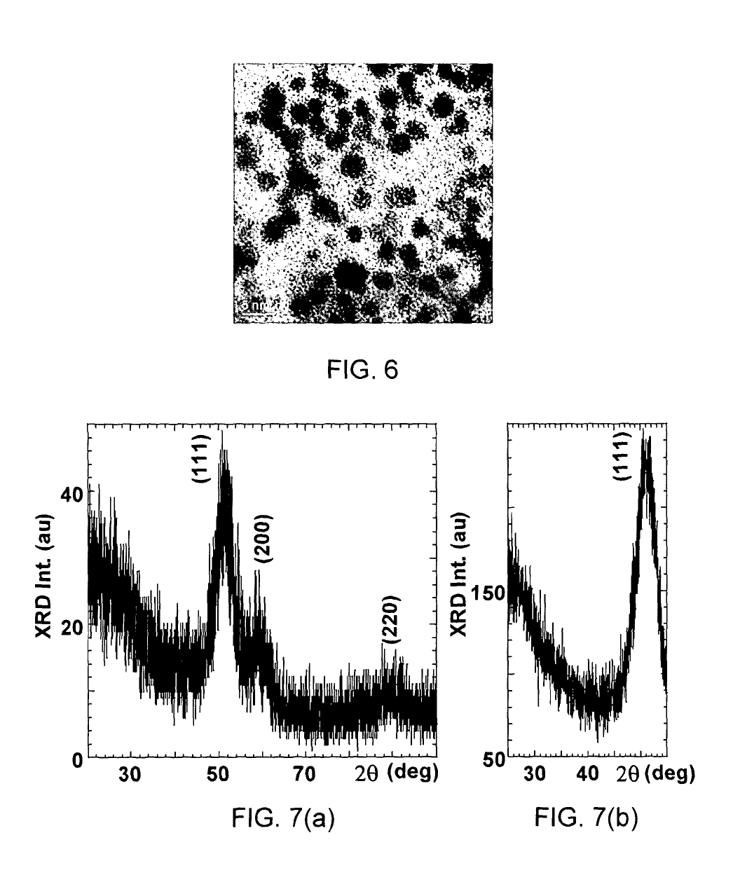

The physical size of the nanoparticles was successfully increased above 3 nm (see FIG. 6), i.e. above the superparamagnetic limit and the crystalline size was determined by XRD. (see FIG. 7). XRD was carried out over 28 ranger over 25 to 100 degree, with 28 step size: 0.02, time/step: 240 s, (B) XRD was carried out over 28 ranger over 25 to 55 degree with 2θ step size: 0.02, time/step: 1800 s.

Consistent with data presented in FIG. 7A, synthesis run at lower heating rate display (111), (200), (220) XRD peaks characteristic of FePt nanoparticles

XRD size was increased by 14% up to 2.5 nm.

However size still <3 nm, while within the experimental uncertainty the % of Fe remained constant slightly around 40%.

Experiments were also carried out with the iron precursor increased by 10% leading to similar results.

### Increasing Size of Nanoparticles: High Concentration of Ligand

Ligand concentration is known to impact naparticles' growth, with the higher concentration of ligand, the more complexes formed and the slower nucleation rate (E. V. Shevchenko et al., infra; S. Saita and S. Maenosono, infra; and V. Nandwana at al., infra). Consequently ligand to precursor was increased by a factor 4. 8 presents the TEM results of this alteration of the protocol (P66614.[NTf₂] as solvent. [Na₂Fe(CO)₄]=[Pt(acac)₂]=0.05 M, [oleylamine]/[Pt(acac)₂]=24, [oleic acid]/[Na₂Fe(CO)₄]=12. Heat rate 5° C./min).

In FIG. 8A, the TEM image does show larger size consistent with the work of Nandwana et al. (V. Nandwana et al., infra)

FIG. 8B shows cubic, triangular, lozenge shapes with very facetted structures.

FIG. 8C shows fringes (stable under beam). Suggests inorganic crystals. Moreover inter spacings between lattice fringes are about 0.48 nm, which are close to (111) planes of Fe₃O₄ at 0.48405 nm, which suggested Fe₃O₄.

FIG. 8D shows inter-fringes spacing 0.228 nm, 0.231 nm, 0.202 nm corresponding to fcc FePt (111′) at 0.2202 nm, (200) lattice planes at 0.1908 nm respectively.

Formation of non-spherical shapes could be induced by high concentration of ligand.

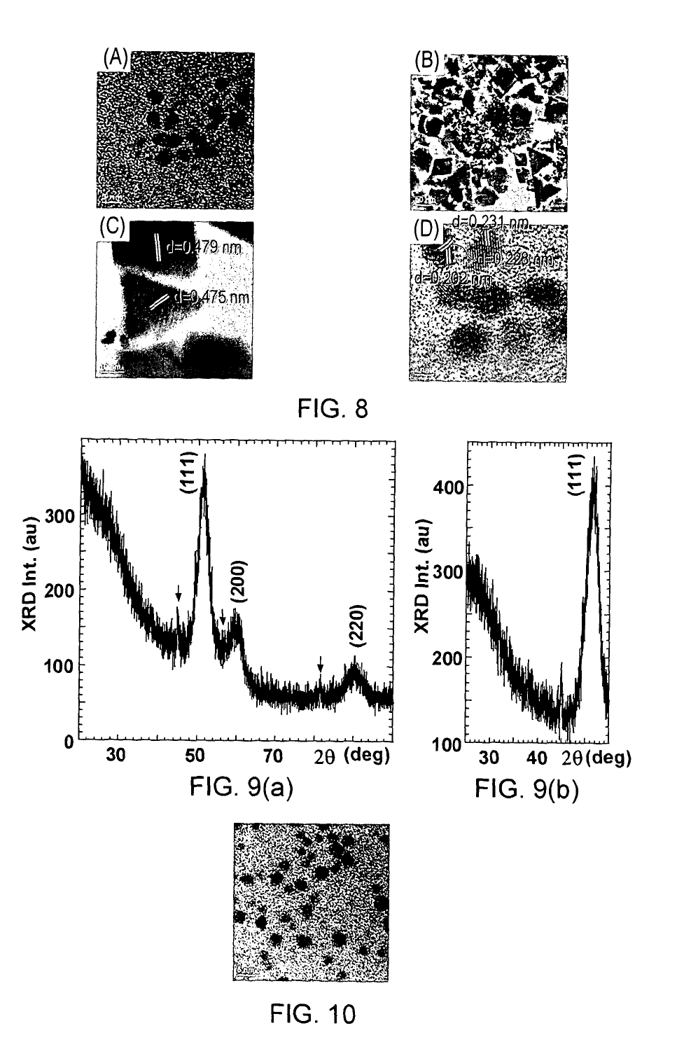

XRD patterns are shown in FIG. 9. XRD was carried out over 2θ ranger over 25 to 100 degree, with 2θ step size: 0.02, time/step: 240 s, (B) XRD was carried out over 2θ ranger over 25 to 55 degree with 2θ step size: 0.02, time/step: 1800 s.

FIG. 9A shows 3 main peaks corresponding FePt (111), (200), (220) peaks. 3 small peaks labeled with arrows indicate the present of Fe₃O₄, they are (311), (400), & (440) peaks. The (111) peak expected to show at around 23 2θ degree is probably covered by high noise background at low 2θ range.

The trace of iron oxide is consistent with the present of cubic or triangular Fe₃O₄ particles suggested by HRTEM imaging. Further confirmation was carried out by EDX which also showed the composition of areas containing cubic & triangular particles is Fe rich

In FIG. 9B (111) XRD peaks characteristic to FePt but no fct peaks, the small peak at about 45 2θ degree corresponding to (311) peak of Fe₃O₄.

Size increased by 85% to 4.1 nm, see 0, above the fct phase formation limit.

TABLE 3
XRD data of FePt NPs synthesised by use P66614•[NTf₂] as solvent.

| [Na₂Fe(CO)₄] = | | | | | | x in |
|---|---|---|---|---|---|---|
| [Pt(acac)₂] | [oleylamine]/ | [oleic acid]/ | 2θ of (111) | a | D_{XRD} | FeₓPt₁₋ₓ |
| M | [Pt(acac)₂] | [Na₂Fe(CO)₄] | (degree) | (Å) | (nm) | (%) |
| 0.05 | 8 | 4 | 51.167 ± 0.015 | 3.8827 ± 0.0011 | 2.5 ± 0.1 | 38.1 ± 0.8 |
| 0.05 | 24 | 12 | 51.410 ± 0.012 | 3.8656 ± 0.0009 | 4.1 ± 0.1 | 42.3 ± 0.7 |
| 0.025 | 16 | 8 | 51.034 ± 0.014 | 3.8921 ± 0.0011 | 2.9 ± 0.1 | 35.8 ± 0.8 |
| injection | 8 | 4 | 51.371 ± 0.007 | 3.8683 ± 0.0005 | 4.0 ± 0.1 | 41.6 ± 0.4 |

Heat rate 5° C./min. 2θ is the position of the (111) peak, a is the lattice constant, D_{XRD} is the crystalline grain size, x is the iron content is FexPt1−x. Crystalline grain size D_{XRD} of FePt samples.

### Increasing Size of Nanoparticles: Decrease Precursors Concentration

Precursor concentration is known to have a strong impact on the growth of nanoparticles and their crystallinity (E. V. Shevchenko et al., infra; S. Saita and S. Maenosono, infra; and V. Nandwana et al., infra). Reduced precursor concentrations were used in order to reduce nucleation rate.

To achieve this while having a constant ligand concentration to compare with our initial experiments, the molar ratio of oleyl amine to Pt(acac)₂ and of oleic acid to Na₂Fe(CO)₄ were multiplied by two, leading to 16 and 8 respectively (P66614.[NTf₂] as solvent. [Na₂Fe(CO)₄]=[Pt(acac)₂]=0.025 M, [oleylamine]/[Pt(acac)₂]=16, [oleic acid]/[Na₂Fe(CO)₄]=8. Heat rate 5° C./min).

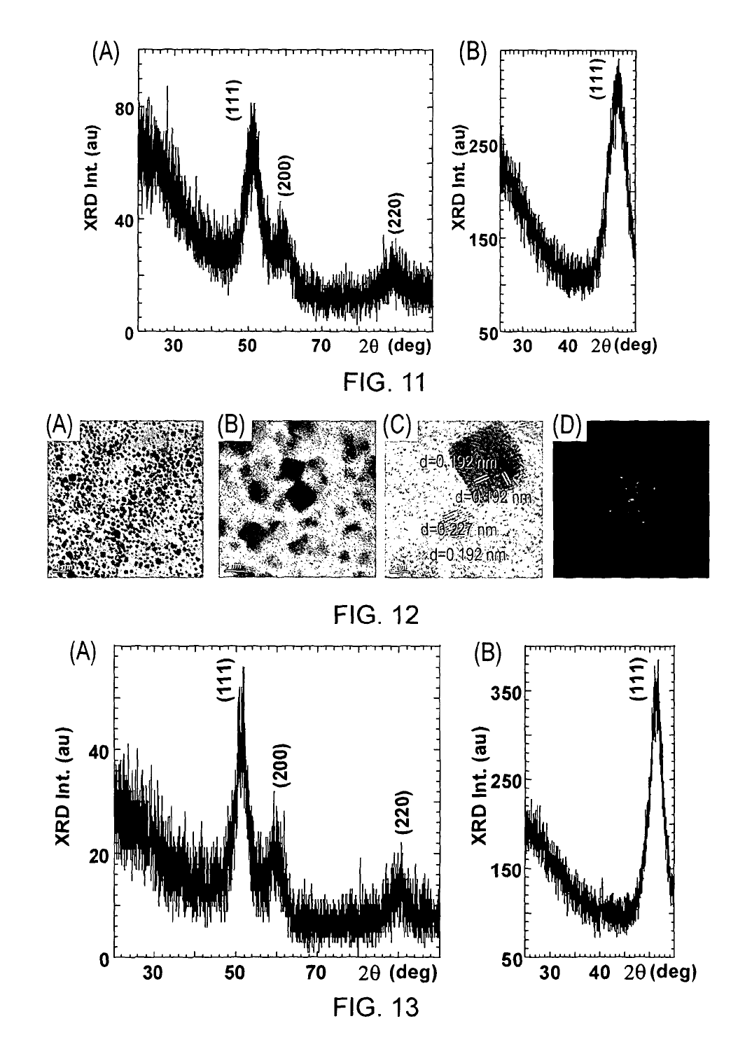

FIG. 10 illustrates a TEM of a typical product of these syntheses. XRD patterns are shown in FIG. 11. XRD was carried out over 28 ranger over 25 to 100 degree, with 2θ step size: 0.02, time/step: 240 s, (B) XRD was carried out over 2θ ranger over 25 to 55 degree with 2θ step size: 0.02, time/step: 1800 s.

XRD reveal the expected feature for FePt nanoparticles.

XRD size was increased by 30%, see 0.

Size of the order of 3 nm but lower than the critical size

% Fe slightly decreased when compared to the other syntheses and even increase Fe precursor by 10%.

### Increasing Size of Nanoparticles: Additional Injection of Precursors

The additional precursor injection protocol is as follows:

Synthesis was started with 4 ml of 0.025 M Na₂Fe(CO)₄ & Pt(acac)₂, [oleylamine]/[Pt(acac)₂]=16, [oleic acid]/[Na₂Fe(CO)₄]=8, heating rate=5° C./min. After heating the main solution to 300° C. for 30 min, additional Fe and Pt precursor solution was injected drop wise for a period of 30 min. After this slow injection, the final [Na₂Fe(CO)₄]=[Pt(acac)₂]=0.05 M. The reaction solution was kept at 300° C. for another 30 min.

The additional Fe & Pt precursors solution were injected according to following sequence: Na₂Fe(CO)₄ was added into 1 mL ionic liquid, [Na₂Fe(CO)₄]=1 M. In another separate jar, Pt precursor & surfactants were added into 1 mL ionic liquid as well, [Pt(acac)₂]=1 M, [oleylamine]/[Pt(acac)₂]=8, [oleic acid]/[Na₂Fe(CO)₄]=4. Both mixtures were kept at 100° C. for 30 min for dissolving purposes, mixed and stirred for 3 min before injection.

A strategy known in the art to increase the size of nanoparticles is to inject, at a rate limiting new nuclei formation, more precursors as the nanoparticles are in their growth phase. This was completed after the synthetic solution reached 300° C. for 30 min and by using the nanoparticles as nuclei while feeding their growth with additional drop-wise injection of precursors. TEM results are presented FIG. 12.

FIG. 12A, polydisperse in size & shape.

FIG. 12B, spherical & cubic NPs. Size of spherical NPs 1-5 nm. Cubic size ˜6 nm.

FIG. 12C, high resolution image. It shows the lattice fringes of cubic NP with inter-fringe spacing of 0.192 nm, close to the lattice spacing of the (200) planes at 0.1908 nm in fcc FePt. The inter-fringe distance of spherical NPs are 0.227 nm & 0.192 nm close to fcc FePt (110) lattice planes at 0.2202 nm & (200) lattice planes at 0.1908 nm. Fast Fourier Transformation (FFT) of the single cube (shown in FIG. 12D) reveals a 4-fold symmetry, consistent with the fcc structure projected from the (200) direction.

Nucleation of new particles competes with growth of already existing ones.

Cubic formation mechanism could be related to higher concentration of ligand as the complexes are being consumed to form nanoparticles and new ones are being introduced drop-wise.

XRD patterns are shown in FIG. 13. XRD was carried out over 2θ ranger over 25 to 100 degree, with 2θ step size: 0.02, time/step: 240 s, (B) XRD was carried out over 2θ ranger over 25 to 55 degree with 2θ step size: 0.02, time/step: 1800 s.

FIG. 13A shows 3 main peaks corresponding FePt (111), (200), (220) peaks.

### Use of [HMI][NTf₂]

### Procedure

The General procedure described above was followed, but in which, after heating up to 150° C. for 1 h, the reaction mixture was further heated up to 340° C. for 1 h before cooling to ambient temperature.

All the syntheses were completed under inert atmosphere, Na₂Fe(CO₄) (0.2 mmol) and a mixture of Pt(acac)₂ (0.2 mmol), oleyl amine (1.6 mmol) and oleic acid (0.8 mmol) were dissolved in separate jars containing 2 mL of [HMI][NTf₂] used as a solvent. After stirring at 100° C. for 1 h, the two solutions were mixed together and the temperature rose up to 150° C. for 1 h. To initiate the reaction, the temperature of the solution was further increased up to 340° C. with a heating rate of 15° C./min. After 1 h, the reaction was stopped, and the solution cooled down to room temperature. Nanoparticles were then precipitated by ethanol addition and by centrifugation. The supernatant was discarded, while the sediment was dispersed in hexane, and precipitated one more time with ethanol and centrifugation.

### Use of Fe(CO)₅:

### Procedure

The General procedure described above was followed, but in which, after heating up to 150° C. for 1 h, the reaction mixture was further heated up to 340° C. for 1 h before cooling to ambient temperature.

All the syntheses were completed under inert atmosphere, a mixture of Pt(acac)₂ (0.2 mmol), oleyl amine (1.6 mmol) and oleic acid (0.8 mmol) were dissolved in separate jars containing 4 mL of [P66614][NTf₂] used as a solvent. After stirring at 100° C. for 1 h, the temperature rose up to 150° C. for 1 h and Fe(CO)₅ (0.2 mmol) was injected. To initiate the reaction, the temperature of the solution was further increased up to 340° C. with a heating rate of 15° C./min. After 1 h, the reaction was stopped, and the solution cooled down to room temperature. Nanoparticles were then precipitated by ethanol addition and centrifugation. The supernatant was discarded, while the sediment was dispersed in hexane, and precipitated one more time with ethanol and centrifugation.

Characterisation of FePt Nanoparticles Synthesised Using Na₂Fe(CO)₄/Pt(acac)₂/[P66614][NTf₂], Fe(CO)₅/Pt(acac)₂/[P66614][NTf₂] and Na₂Fe(CO)₄/Pt(acac)₂/[HMI][NTf₂]

FePt nanoparticles were synthesised using Na₂Fe(CO)₄/Pt(acac)₂/P66614][NTf₂] according to the General procedure described above, but in which, after heating up to 150° C. for 1 h, the reaction mixture was further heated up to 340° C. for 1 h before cooling to ambient temperature.

FePt nanoparticles were synthesised using Fe(CO)₅/Pt(acac)₂/P66614][NTf₂] and Na₂Fe(CO)₄/Pt(acac)₂/[HMI][NTf₂] as described above.

Fct-ordered FePt is revealed in XRD spectra (Fe_{Kα1} source (λ=1.936 Å)) by the presence of two peaks at around 29 and 34° corresponding to fct-FePt ((001), (110) peaks respectively (FIG. 14(a)-(c)). The order parameter (also referred to as the chemical ordering parameter) displayed in Table 4 below were extracted, as described in the literature, from the ratio of experimental intensity (110) and (111) XRD peaks and the values reported for the bulk and was based upon the PDF library card 03-065-9121.

TABLE 4
Characterisation of FePt nanoparticles synthesised using Na₂Fe(CO)₄/Pt(acac)₂/[P66614][NTf₂], Fe(CO)₅/
Pt(acac)₂/[P66614][NTf₂] and Na₂Fe(CO)₄/Pt(acac)₂/[HMI][NTf₂]: peak position (2θ), lattice constant (a),
crystalline grain diameter (D_{XRD}) iron content (x) in FeₓPt₁₋ₓ, crystalline order parameter (S), blocking temperature (T_{b}),
coercivity (H_{c}), magnetization at saturation (Mₛ), remanent magnetization (Mᵣ) and their ratio (Mₛ/Mᵣ).

| Fe | (110) | (111) | | | | H_{c} | | Mₛ | | Mᵣ | | Mᵣ/Mₛ | |
|---|---|---|---|---|---|---|---|---|---|---|---|---|---|
| precursor/ | 2θ (deg.)/ | 2θ (deg.)/ | D_{XRD} | S | T_{b} | 2K | 300K | 2K | 300K | 2K | 300K | 2K | 300 K |
| Solvent | d (Å) | d (Å) | (nm) | (—) | (K) | (kOe) | | (emu/g) | | (emu/g) | | (—) | |
| Na₂Fe(CO)₄/ | 42.2/2.689 | 51.477/2.229 | 7.0 ± 0.2 | 0.59 | 165 | 2.1 | 0 | 16.9 | 5.9 | 6.2 | 0 | 0.37 | 0 |
| [P₆₆₆₁₄][NTf₂] | | | | | | | | | | | | | |
| Fe(CO)₅/ | 41.2/2.752 | 51.409/2.232 | 10.3 ± 0.2 | 0.50 | 162 | 1.9 | 0 | 14.7 | 7.6 | 7.4 | 0 | 0.50 | 0 |
| [P₆₆₆₁₄][NTf₂] | | | | | | | | | | | | | |
| Na₂Fe(CO)₄/ | 41.5/2.731 | 51.443/2.230 | 11.9 ± 0.6 | 0.63 | 260 | 1.8 | 0.06 | 21.5 | 12.3 | 11.6 | 0.71 | 0.54 | 0.06 |
| [HMI][NTf₂] | | | | | | | | | | | | | |

### Synthesis of CoPt Nanoparticles:

These may be synthesised using procedures analogous to those described above for FePt nanoparticles. Thus, for example, all the syntheses are completed under inert atmosphere, a mixture of Pt(acac)₂ (0.2 mmol), oleyl amine (1.6 mmol) and oleic acid (0.8 mmol) are dissolved in separate jars containing 4 mL of [P₆₆₆₁₄][NTf₂] used as a solvent. After stirring at 100° C. for 1 h, the temperature is elevated to 150° C. for 1 h and Co(CO)₅ (0.2 mmol) is injected. To initiate the reaction, the temperature of the solution is further increased up to 340° C. with a heating rate of 15° C./min. After 1 h, the reaction is stopped, and the solution cooled down to room temperature. Nanoparticles are then precipitated by ethanol addition and centrifugation. The supernatant is discarded, while the sediment is dispersed in hexane, and precipitated one more time with ethanol and centrifugation.

1. A method of directly synthesising fct FePt or CoPt nanoparticles in an ionic liquid comprising heating in the ionic liquid a mixture comprising a substrate that is capable of providing platinum atoms and a substrate that is capable of providing iron atoms or cobalt atoms to provide said fct FePt or CoPt nanoparticles.

2. A method of synthesising FePt or CoPt nanoparticles in an ionic liquid comprising heating in the ionic liquid a mixture comprising a substrate that is capable of providing platinum atoms and a substrate other than iron pentacarbonyl that is capable of providing iron atoms or a substrate that is capable of providing cobalt atoms to provide said FePt or CoPt nanoparticles.

3. The method of claim 2 wherein fct nanoparticles are synthesised directly by the method.

4. The method of claim 1 wherein the ionic liquid comprises one or more materials selected from tetradecyl(trihexyl)phosphonium bistriflamide, 1-butyl-3-methylimidazolium bis(trifluoromethylsulfonyl) imide, 1-n-butyl-3-methylimidazolium hexafluorophosphate, 1,1,3,3-tetramethylguanidinium lactate, N-butyl-pyridinium tetrafluoroborate, 1-butyl-3-methylimidazolium tetrafluoroborate, 1-ethyl-3-methylimidazolium bis(trifluoromethyl sulfonyl)imide 1-ethyl-3-methyl-imidazolium tetrafluoroborate and 1-butyl-1-methyl-pyrrolidinium trifluoromethanesulfonate.

5. The method of claim 1 wherein the ionic liquid comprises anions that allow simultaneous bonding to a substrate capable of providing platinum atoms and a substrate capable of providing iron or cobalt atoms,

6. The method of claim 5 wherein the ionic liquid comprises bis(triflylmethyl sulfonyl)imide anions.

7. (canceled)

8. The method of claim 1 wherein FePt nanoparticles are made and the substrate that is capable of generating iron atoms is an iron (II)-, an iron (III)-, an iron(0)- or an iron(-II)-containing compound.

9. The method of claim 1 wherein FePt nanoparticles are made and the substrate that is capable of generating iron atoms is a cationic or an anionic iron-containing compound.

10. (canceled)

11. The method of claim 8 wherein the substrate that is capable of generating iron atoms is Na₂Fe(CO)₄.

12. The method of claim 1 wherein the mixture additionally comprises a substrate that is capable of providing silver atoms.

13. The method of claim 1 wherein the mixture provides nanoparticles having a size between about 2.8 and about 4 nm.

14. The method of claim 1 wherein the heating is conducted for a time from about 15 minutes to about 4 hours.

15. The method of claim 1 wherein the heating is conducted at a temperature of from about 250 to about 400° C.

16. The method of claim 15 wherein, prior to heating at a temperature of from about 250 to about 400° C., the mixture is heated at 80 to about 200° C., for a period of between about 15 minutes and about 3 hours.

17. FePt or CoPt nanoparticles obtainable by a method as defined in claim 1.

18. The method of claim 2 wherein the mixture additionally comprises a substrate that is capable of providing silver atoms.

19. FePt or CoPt nanoparticles obtainable by a method as defined in claim 16.

20. The method of claim 2 wherein, prior to heating at a temperature of from about 250 to about 400° C., the mixture is heated at 80 to about 200° C., for a period of between about 15 minutes and about 3 hours.

21. FePt or CoPt nanoparticles obtainable by a method as defined in claim 2.
